(19) United States
(12) Patent Application Publication
(10) Pub. No.: US 2007/0223960 A1
(43) Pub. Date: Sep. 27, 2007

(54) CLAMPING APPARATUS AND IMAGE PROCESSING APPARATUS UTILIZING THE SAME

(76) Inventors: Ta-Yi Lee, Taipei County (TW); Jeicy Lee, Guangzhou (CN); JY Tang, Xiangtan City (CN)

Correspondence Address: NORTH AMERICA INTELLECTUAL PROPERTY CORPORATION, P.O. BOX 506, MERRIFIELD, VA, 22116, US

(21) Appl. No.: 11/383,498

(22) Filed: May 16, 2006

(30) Foreign Application Priority Data
Mar. 23, 2006 (TW) 095204892

(51) Int. Cl. G03G 15/00

(52) U.S. Cl. 399/107

(57) ABSTRACT

A clamping apparatus capable of fixing an object is disclosed. The clamping apparatus comprises: a carrier for holding the object; at least one flexible orientation arm with a raised rim positioned on the carrier for orientating the object; and a cover for pressing the raised rim and for clamping the object on the carrier.

### BACKGROUND OF THE INVENTION

1. Field of the Invention

The present invention relates to a clamping apparatus, and more particularly, to a clamping apparatus with at least one flexible orientation arm, and an image processing apparatus utilizing the same.

2. Description of the Prior Art

As digital techniques develop, image data are increasingly saved in a digital format. For example, conventional images files such as photographs and documents can be scanned into digital image formats and then be saved, processed and modified in computers.

Related art image processing apparatus require a clamp to fix the documents. Please refer to FIG. 1. FIG. 1 is a schematic diagram of a prior art clamping apparatus 100. The clamping apparatus 100 is a photograph fixture, comprising a carrier 110, a cover 120 and a pivot element 130. The cover 120 can rotate relative to the carrier 100 through the pivot element 130.

As shown in FIG. 1, the black print paper 112 against the white surface of the carrier 110 is used as guidance for a user to orient a photograph. Thereafter, the cover 120 is rotated relative to the carrier 110 and then lies flat on the carrier 110 in order to fix the photograph. Finally, the clamping apparatus 100 is placed on an image transparent flat-top or installed into the backlight board of an image process system for performing a scanning process.

In the clamping apparatus 100, the glass within the cover 120 is fixed and larger than the height of a specific photograph. When the cover 120 lies flat on the carrier 110, the photograph will be moved slightly due to the pressure produced by the contact between the cover 120 and the photograph. As a result, the photograph needs to be adjusted to the correct position.

### SUMMARY OF THE INVENTION

According to the present invention, a clamping apparatus capable of fixing an object is disclosed. The clamping apparatus comprises: a carrier for holding the object; at least one flexible orientation arm with a raised rim positioned on the carrier, for orientating the object; and a cover for pressing the raised rim and for clamping the object on the carrier.

According to the present invention, an image processing device is disclosed. An image processing device comprises: a clamping apparatus comprising: a carrier for holding the object; at least one flexible orientation arm with a raised rim positioned on the carrier for orientating the object; and a cover for pressing the raised rim and for clamping the object on the carrier; and an image processing module, for performing a predetermined image process on the object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a prior art clamping apparatus 100.

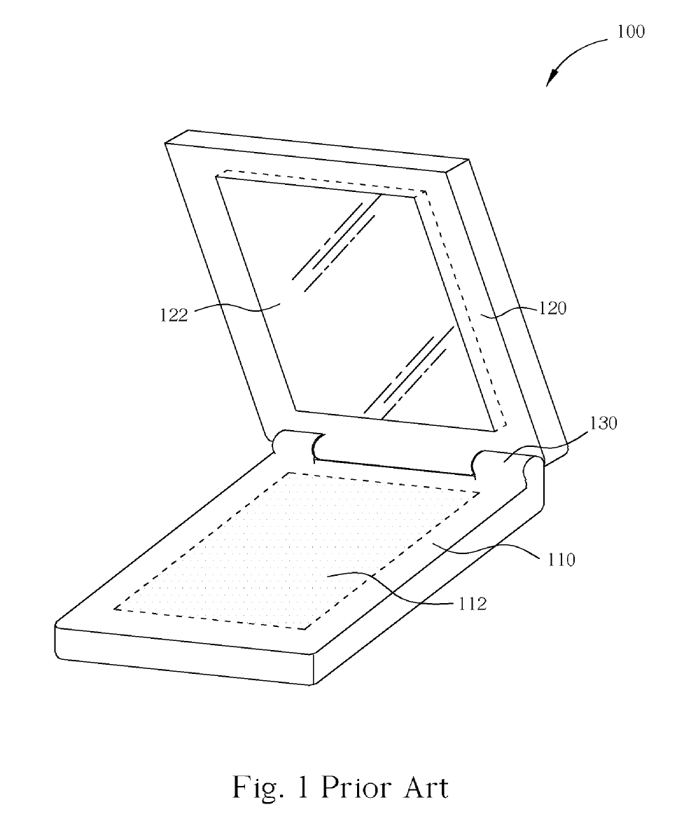

FIG. 2 is a schematic diagram of a clamping apparatus according to an embodiment of the present invention.

FIG. 3 is a schematic diagram of a photograph fixed in the clamping apparatus by the flexible orientation arm before the cover is pressed to the carrier.

FIG. 4 is a top view of the cover pressed to the carrier.

FIG. 5 is a schematic diagram of an image processing device according to an embodiment of the present invention.

### DETAILED DESCRIPTION

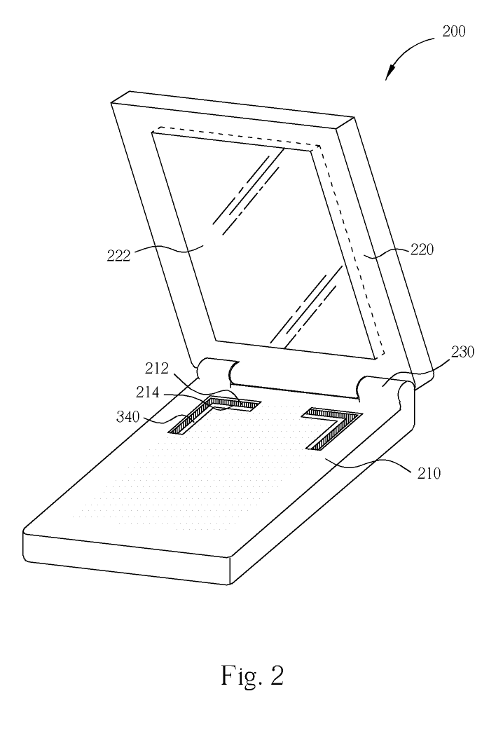

Please refer to FIG. 2. FIG. 2 is a schematic diagram of the clamping apparatus 200 according to an embodiment of the present invention. In this embodiment, the clamping apparatus 200 is used to fix a photograph. As shown in FIG. 2, the clamping apparatus 200 comprises a carrier 210, a cover 220, and a pivot element 230 through which the cover 220 can pivot upon the carrier 210 and buckle onto it.

The carrier 210 is used to carry an object (for example a photograph). There is at least one flexible orientation arm on the carrier 210 to orientate the object. Please note that, in this embodiment, FIG. 2 shows two flexible orientation arms installed on different corners of the carrier. The present invention is not limited to the number and position of the flexible orientation arms, however. The cover 220 comprises a piece of glass 222 which can compress the flexible arm 212 and then fix the object on the carrier 210 when the cover 220 is pressed to it.

Please note that in FIG. 2 the flexible orientation arm 212 and the carrier 210 are formed from one molding. In other words, the flexible orientation arms 212 are L-shaped and the two arms of the L are connected to the carrier 210. The opposite sides of the L (i.e. the raised rim 214) are separated from the carrier 210 by gaps (such as gap 340). The raised rim 214 of the flexible orientation arm 212 is raised from the carrier 210, so when the cover moves down the gap 340 will form between the carrier 210 and the flexible orientation arms 212. The gap 340 then serves as a buffer of the flexible orientation arm 212.

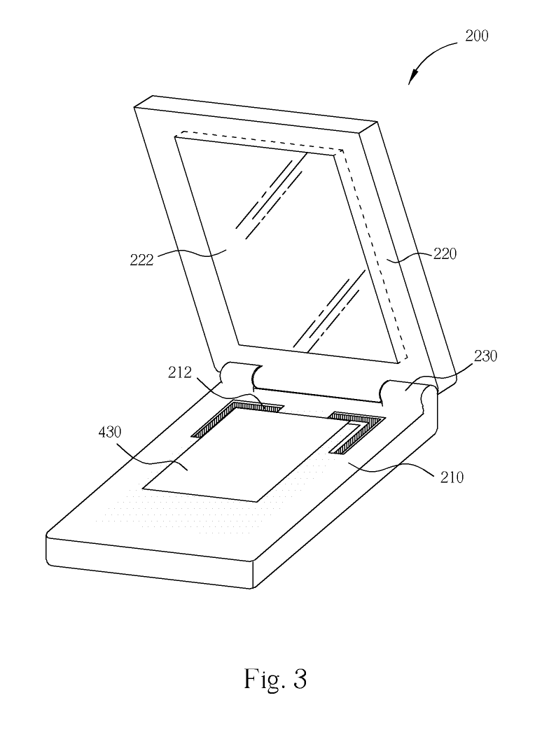

Please refer to FIG. 3. FIG. 3 is a schematic diagram of a photograph fixed in the clamping apparatus 200 by the flexible orientation arm 212 before the cover 220 is pressed to the carrier 210. The photograph 430 is orientated to be aligned with one of the two perpendicular arms (the raised rim 214) of the L-shaped flexible orientation arms 212. Because the flexible orientation arms 212 are relaxed before the cover 220 moves down, the raised rim 214 will be higher than the thickness of the photograph 430.

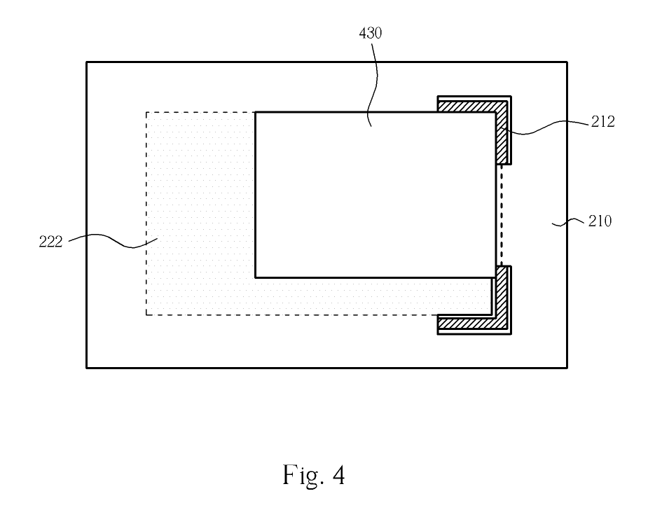

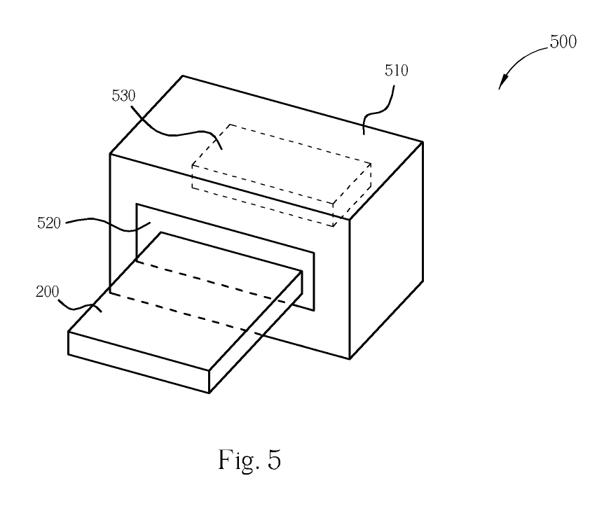

Please refer to FIG. 4. FIG. 4 is a top view of the carrier 210 pressed to the cover 220. Please note that, in order to make the description easily comprehendible, the cover 220 is not illustrated in FIG. 5. After the photograph 330 is fixed on the carrier 210 the cover 220 will move down to buckle onto the carrier 210. Near completion of the moving-down process, the cover 220 will not touch the photograph 330 but will rather touch the flexible orientation arms 220 first. As a result, the horizontal loading produced by the cover 220 to the photograph 430 is minimal once the cover 220 moves down low enough to touch the photograph 430. In other words, as the cover 220 goes down, the height of the flexible orientation arms 220 will be compressed to the extent of the photograph's height. With the flexible orientation arms 202 serving as a buffer, the photograph 430 will not slip as the cover 220 goes down.

Please refer to FIG. 5. FIG. 5 is a schematic diagram of the image processing device 500 according to an embodiment of the present invention. The image processing device 500 uses the above clamping apparatus 200 to fix the object requiring processing (e.g. a photograph). As shown in FIG. 6, the image processing device 500 comprises a housing 510, itself comprising: an opening 520, for insertion of the clamping apparatus 200; and an image processing module 530, for processing the image fixed in the clamping apparatus 200. Please note that the design of the opening is not limited to the present embodiment. Any design compatible with the clamping apparatus for image processing falls within the scope of the present invention.

In the embodiment shown in FIG. 5, the image processing module 530 is higher than the clamping apparatus 200, which is inserted to the image processing device 500 through the opening 520 so that the image processing module 530 can process the photograph fixed in the clamping apparatus 200. For example, the image processing module 530 can be a scanning module for scanning the object (e.g. a photograph) fixed in the clamping apparatus 200. However, in another embodiment of the image processing device, the image processing module 530 can have other functions. In addition, the image processing module can be installed into other positions as required. For example, the image processing module 530 can be a printing module for printing the object fixed in the clamping apparatus 200.

Please note that the present example is just one embodiment of the present invention and is used here merely for the purpose of description. The present invention is not limited to those embodiments shown in the figures. According to the essence of the present invention and practical requirements, the invented clamping apparatus can fix any other size of object (e.g. a photograph or document), and more than one flexible orientation arm can be utilized as required. Furthermore, the present invention clamping apparatus can be adapted to any image processing devices that require fixtures for objects needing processing.

Compared to the related art, the present invention has a simpler structure; the flexible orientation arms and the carrier are formed from only one molding so that the original cost of black print paper for placing against the white surface of the carrier can be saved. The flexible orientation arms are not only easy to use but also provide clear guidance for orientating the objects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A clamping apparatus capable of clamping an object, comprising:
a carrier, for carrying the object;
at least one flexible orientation arm, positioned on the carrier and including a raised rim for orientating the object; and
a cover, for pressing the raised rim and for clamping the object on the carrier.

2. The clamping apparatus of claim 1, having a plurality of flexible orientation arms positioned on different corners of the carrier respectively.

3. The clamping apparatus of claim 1, wherein the raised rim contains two rims perpendicular to each other.

4. The clamping apparatus of claim 1, further comprising a pivot element coupled to the carrier and the cover, for allowing the cover to pivot on the carrier in order to press the carrier.

5. The clamping apparatus of claim 1, wherein the cover comprises a glass, and the glass presses the object to fix the object onto the carrier when the cover presses the raised rim.

6. The clamping apparatus of claim 1, wherein the object is a photograph.

7. An image processing device comprising:
a clamping apparatus comprising:
a carrier, for carrying the object;
at least one flexible orientation arm, positioned on the carrier and including a raised rim for orientating the object; and
a cover, for pressing the raised rim and for clamping the object on the carrier; and
an image processing module, for performing a predetermined image process on the object.

8. The image processing device of claim 7, further comprising a housing, wherein the housing has an opening, the image processing module is positioned inside the housing, and the clamping apparatus is removably installed in the image processing device through the opening.

9. The image processing device of claim 7, wherein the image processing module is a scanning module or a photocopy module.

10. The image processing device of claim 7, wherein the image processing device is a scanner, a photocopier, or a multifunction printer.

11. The image processing device of claim 7, having a plurality of flexible orientation arms positioned on different corners of the carrier respectively.

12. The image processing device of claim 7, wherein the raised rim contains two rims perpendicular to each other.

13. The image processing device of claim 7, further comprising a pivot element coupled to the carrier and the cover, for allowing the cover to pivot on the carrier for pressing the carrier.

14. The image processing device of claim 7, wherein the cover comprises a glass, and the glass presses the object to fix the object onto the carrier when the carrier presses the raised rim.

15. The image processing device of claim 7, wherein the object is a photograph.
